(19) United States
(12) Patent Application Publication
(10) Pub. No.: US 2009/0129214 A1
(43) Pub. Date: May 21, 2009

(54) MEMORY CONTROL DEVICE

(76) Inventor: Yasuyuki Tomida, Osaka (JP)

Correspondence Address: WENDEROTH, LIND & PONACK L.L.P., 1030 15th Street, N.W., Suite 400 East, Washington, DC, 20005-1503, US

(21) Appl. No.: 11/995,302

(22) PCT Filed: Jul. 4, 2006
(86) PCT No.: PCT/JP2006/313339

§ 371 Date: Jan. 10, 2008

(30) Foreign Application Priority Data
Jul. 11, 2005 (JP) 2005-201493

(51) Int. Cl. G11B 7/085

(52) U.S. Cl. 369/30.03; G9B/7.042

(57) ABSTRACT

To provide a memory control circuit in which the bandwidth that is required for the refresh operation is appropriately divided so as to perform smoothing of the peak bandwidth for the memory accesses, and thereby the refresh operations that are required can be accomplished with a low peak bandwidth. A normal time refreshment requester circuit which normally raises a refreshment request for refreshing the memory to the access arbitrator circuit, and a first and second concentrated refreshment requester circuits corresponding to the first and second requesters which in a concentrated manner issues refreshments during while the refreshment request issuing conditions are satisfied such as in a time domain in which the bandwidth for memory accesses are lowered are operated in parallel.

### TECHNICAL FIELD

The present invention relates to a memory access control device, and more particularly, to a memory access control circuit for controlling a memory that requires refreshment.

### BACKGROUND ART

In a system LSI in recent years, integrating two or more functions on a single chip is often carried out. To that end, an integrated memory architecture integrating memories which have been conventionally inherent to individual function blocks respectively is adopted in order to realize a reduced system cost and lowered power consumption.

In the integrated memory architecture, it is required that the sum of the peak bandwidths which are respectively required by the respective function blocks for all the function blocks is within a certain peak bandwidth. If the above-mentioned sum of the peak bandwidths is large, countermeasures thereto, such as increasing the memory bath width or raising the operation frequency of the memory, which in turn unfavorably affect the advantages of the integrated memory architecture, are required. Therefore, the peak bandwidth is required to be as small as possible.

On the other hand, a SDRM or a DDR-SDRAM of high speed and large capacity is suitable for such an integrated memory in a system LSI. However, since these volatile memories require refresh operations and these refresh operations are carried out with competing with usual memory accesses as well as with dissipating the bandwidth, it was a subject that the refresh operation should be carried out without affecting the peak bandwidth (patent reference 1).

As means for solving the above-described subject, there have been conventionally adopted two methods as follows. One among these two is carrying out a required number of refreshments within a predetermined time period evenly, thereby to assign a predetermined bandwidth on normal time refreshment (hereinafter called as “normal time refreshment”), while the other among those is carrying out refreshments in a concentrated manner in a time domain in which the frequency of the normal memory access is lowered, thereby to complete all the refreshments which are to be carried out in a predetermined time period in a short time (hereinafter referred to as “concentrated refreshment).

As a method of performing concentrated refreshment, there is typically a method of performing it using the time domain where the access frequency is lowered in such as vertical blanking periods in the video image, in such as a system LSI that perform an AV processing. Patent documents 1: Japanese Patent Publication No. 2000-311484

### DISCLOSURE OF THE INVENTION

### Problems to be Solved by the Invention

In such a memory access control circuit for controlling a memory that requires refreshments described above, the time number of refreshments which are required increases by power of 2 with an increase in the memory capacity, and therefore, the bandwidth that is occupied by the refreshment would also increase by power of 2 with an increase in the memory capacity.

In these situations, the above-described two methods involve issues as described in the following.

As for the normal time refreshment, since in situations where the accesses for the respective function blocks are concentrated to generate a peak, the bandwidth for the refreshments are congested thereon as they are, and therefore, the peak bandwidth that is to be compensated would unfavorably be increased.

On the other hand, the issues which exist in the normal time refreshments would not occur in the concentrated refreshments. However, since the required number of refreshments are all carried out during a short time band when the access frequency is low, the bandwidth for refreshments would increase during the time band in which refreshments are concentrated. Then, in cases where memories of large capacities which require a larger refreshment number are employed, the bandwidth for the refreshments would exceeds in a large way the occupation bandwidth that has been reduced due to the access frequency reduction, which reversely and unfavorably result in a higher peak bandwidth.

The present invention is directed to solving the above-described conventional problems and has for its object to provide a memory control device which can perform smoothing of the peak bandwidth for memory accesses and accomplish required refreshment operations with a low peak bandwidth by appropriately dividing the bandwidths required for refreshment operations.

### Measures to Solve the Problems

According to claim 1 of the present invention, there is provided a memory control device which arbitrates and controls accesses from plural requesters which raise access requests to a memory that requires refreshments, thereby to perform a memory control, comprising a memory access control circuit comprising an access arbitrator circuit which arbitrates memory access requests from the plural requesters, and plural refreshment requester circuits which raise requests for performing refreshment of the memory to the access arbitrator circuit, and the plural refreshment requester circuits include a normal time refreshment requester circuit which continuously outputs a refreshment request for refreshing the memory to the access arbitrator circuit, or always outputs a refreshment request for refreshing the memory at a constant time interval to the access arbitrator circuit, and one or plural conditioned refreshment request circuits which continue to issue refreshment requests for refreshing the memory to the access arbitrator circuit during while the refreshment request issuing conditions which are respectively set for the conditioned refreshment request circuits are satisfied.

According to claim 2 of the present invention, there is provided a memory control device as defined in claim 1 wherein all or a part of the plural requesters output an access frequency reduced signal which is being ON when the access frequency to the memory is below a predetermined value to the memory access control circuit, the conditioned refreshment requester circuits are provided in the same number as all or a part of the requesters which output the access frequency reduced signal, and the refreshment request issuing conditions for the respective conditioned refreshment requester circuits are that the corresponding access frequency reduced signals are being ON.

According to claim 3 of the present invention, there is provided a memory control device as defined in claim 2, wherein the access allowance frequency that is set for the conditioned refreshment requester circuit in the memory access arbitrator circuit is set based on the difference between the value when the access frequency reduced signal that is outputted from the conditioned refreshment requester circuit is OFF and that value when it is ON, and the access allowance frequency that is set for the normal time refreshment requester circuit in the memory access arbitrator circuit is set so that refreshments of the number that is equal to the difference between the refreshment time number which are required for the memory to be performed in a predetermined time period and the refreshment time number which are carried out by the conditioned refreshment request circuit in the predetermined period of time are able to be carried out in the predetermined time period.

According to claim 4 of the present invention, there is provided a memory control device as defined in claim 3, wherein the requesters which issues memory access requests to the access arbitrator circuit are image processing circuits which carry out image processing; the requesters being image processing circuits periodically repeat active periods during when the accesses to the external memory are frequent and blank periods during when the accesses are seldom, and the memory access control circuit has conditioned refreshment requester circuits corresponding to the requesters being the image processing circuits, and employs signals which indicate that the requesters which are image processing circuits are in the blanking periods, as the access frequency reduced signals.

### EFFECTS OF THE INVENTION

According to the memory control device according to claim 1 or claim 2, it is possible to appropriately mix the normal time refreshment and the concentrated refreshment, and thereby it is possible to avoid the generation of a high peak bandwidth due to peaks in memory accesses and congestion of refreshments.

In addition, according to the memory control device according to claim 3, it is possible to provide a memory access control method which is simple and which can realize the normal time refreshment and the concentrated refreshment with a predetermined ratio, in order to reduce the peak bandwidth, being constructed from the information of the bandwidth variation which can be seen a priori.

In addition, according to the memory control device according to claim 4, it is possible to provide a memory access control method which is simple and which can reduce the peak bandwidth for the refreshments in an information processing apparatus which handles video images.

### BRIEF DESCRIPTION OF THE DRAWINGS

FIG. 1 is a diagram illustrating a construction of a memory control device according to a first embodiment of the present invention.

FIG. 2 is a conceptual diagram illustrating refresh operations when a normal time refreshment and two concentrated refreshments are carried out.

FIG. 3 is a conceptual diagram illustrating refresh operations when refreshments are carried out only by the normal time refreshments.

FIG. 4 is a conceptual diagram illustrating refresh operations when the refreshments are carried out only by the two concentrated refreshments.

### DESCRIPTION OF REFERENCE NUMERALS

1000 . . . memory control device
100 . . . memory access control circuit
10 . . . external memory
20 . . . first requester
21 . . . second requester
30 . . . normal time refreshment requester
40 . . . first concentrated refreshment requester
41 . . . second concentrated refreshment requester
50 . . . regular refreshment frequency register
60 . . . first concentrated refreshment frequency register
61 . . . second concentrated refreshment frequency register
70 . . . first requester frequency reduced signal
71 . . . second requester frequency reduced signal
80 . . . first concentrated refreshment request signal
81 . . . second concentrated refreshment request signal
82 . . . normal time refreshment request signal
90 . . . normal time refreshment cycle counter
A0 . . . first concentration refreshment cycle counter
A1 . . . second concentration refreshment cycle counter
B0 . . . arbiter

### BEST MODE FOR CARRYING OUT THE INVENTION

### First Embodiment

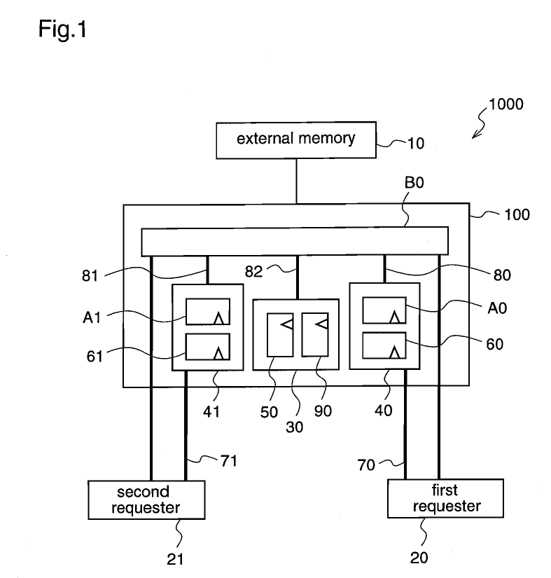

A memory control device according to a first embodiment of the present invention will be described with reference to FIG. 1.

FIG. 1 is a diagram illustrating a memory control device 1000 according to a first embodiment of the present invention.

In the memory control device 1000 shown in FIG. 1, a memory access control circuit 100 is a circuit which controls the accesses from plural requesters to a memory which requires refreshments. This memory control circuit 100 is connected to an external memory 10 which requires refreshments and is also connected to a first requester 20 and a second requester 21 which both issue access requests to the external memory 10.

In addition, the memory access control circuit 100 includes a normal time refreshment requester 30 which includes therein a normal time frequency register 50 and a normal time refreshment cycle counter 90, a first concentrated refresh requester 40 which includes therein a first concentrated refreshment frequency register 60 and a first concentrated refresh counter A0, a second concentrated refresh requester 41 which includes therein a second concentrated refreshment frequency register 61 and a second concentrated refreshment cycle counter A1, and an arbiter B0.

The arbiter B0 is connected to the first requester 20, the second requester 21, the normal time refreshment requester 30, the first concentrated refreshment requester 40, and the second concentrated refreshment requester 41, and receives the requests from the respective units and arbitrates those, i.e., accepts those with giving priority in the order of the normal time refreshment requester 30, the first concentrated refreshment requester 40, the second concentrated refreshment requester 41, the first requester 20, and the second requester 21.

The memory access control circuit 100 issues a command to the external memory 10 according to the requester which is selected by the arbiter B0. Particularly, when any of the normal time refreshment requester 30, the first concentrated refreshment requester 40, and the second concentrated refreshment requester 41 is selected, it issues a refreshment command to the external memory 10. Here, the cycle number that is required for refreshment is set to 20 cycles.

The normal time refreshment register 30 has the normal time refreshment frequency register 50 and the normal time refreshment cycle counter 90 therein, and is connected to the arbiter B0 via the normal time refreshment request signal 82.

The normal time refreshment cycle counter 90 is a counter which is incremented by one in a cycle, and when its counter value reaches a value equal to the set value of the normal time refreshment frequency counter 50, it returns to 0 at next cycle. When the value of the normal time refreshment frequency register 50 and the value of the normal time refreshment cycle counter 90 are equal to each other, the normal time refreshment requester 30 makes the normal time refreshment request signal 82 ON, thereby issuing a request to the arbiter B0.

The first concentrated refreshment requester 40 includes the first concentrated refreshment frequency register 40 and the first refreshment cycle counter A0 therein, and it is connected to the arbiter B0 via the first concentrated refreshment request signal 80 and is connected to the first requester 20 via the first requester frequency reduced signal 070.

The first concentrated refreshment cycle counter A0 is a counter which is incremented by one in a cycle only when the first requester frequency reduced signal 70 is ON, and when its counter value reaches a value that is equal to the set value of the first concentrated refreshment frequency counter 60, it returns to 0 at next cycle. When the value of the first concentrated refreshment frequency register 60 and the value of the first concentrated refreshment cycle counter A0 are equal to each other, the first concentrated refreshment requester 40 makes the first refreshment request signal 80 ON, thereby issuing a request to the arbiter B0.

The second concentrated refreshment requester 41 includes the second concentrated refreshment frequency register 61 and the second concentrated cycle counter A1 therein, and it is connected to the arbiter B0 via the second concentrated refreshment register 81 and is connected to the second requester 21 via the second requester frequency reduced signal 71.

The second concentrated refreshment cycle counter A1 is a counter which is incremented by one in a cycle only when the second requester frequency reduced signal 71 is ON, and when the value of the counter is equal to the set value of the second concentrated refreshment frequency counter 61, it returns to 0 at the next cycle. When the value of the second concentrated refreshment frequency register 61 and the value of the second concentrated refreshment cycle counter A1 are equal to each other, the second concentrated refreshment requester 41 makes the second refreshment request signal 81 ON, thereby issuing a request to the arbiter B0.

It is assumed to be previously known that the first requester 20 and the second requester 21 have the following characteristics concerning the memory access requests. Particularly, a time period during when accesses are frequent continues for 15.2 ms, and a time period during when access frequency is low continues for 1.4 ms. These time periods are repeated periodically.

The first requester 20 makes the first requester frequency reduced signal 70 OFF during the active period while makes the first requester frequency reduced signal 70 ON during the blanking period. In addition, the second requester 21 makes the second requester frequency reduced signal 71 OFF during the active period while makes the second requester frequency reduced signal 71 ON during the blanking period.

It is assumed that the peak in the required occupied bandwidth in the active period of the first requester 20 is approximately 40 MHz while the required occupied bandwidth in the blanking period of the first requester 20 is approximately 35 MHz. On the other hand, it is assumed that the peak in the required occupied bandwidth in the active period of the second requester 21 is approximately 20 MHz while the required occupied bandwidth in the blanking period of the second requester 21 is approximately 10 MHz.

Further, it is assumed that the second requester 21 and the first requester 20 are requesters which are asynchronously operated with each other, and the start times of the active periods or the blank periods of the both requesters do not coincide with each other.

The external memory 10 is required to carry out 8192 times of refreshments during a time period of 64 ms, and when a request command is once issued, 20 cycles are required.

Next, an operation of the memory control device 1000 according to the first embodiment of the present invention will be described.

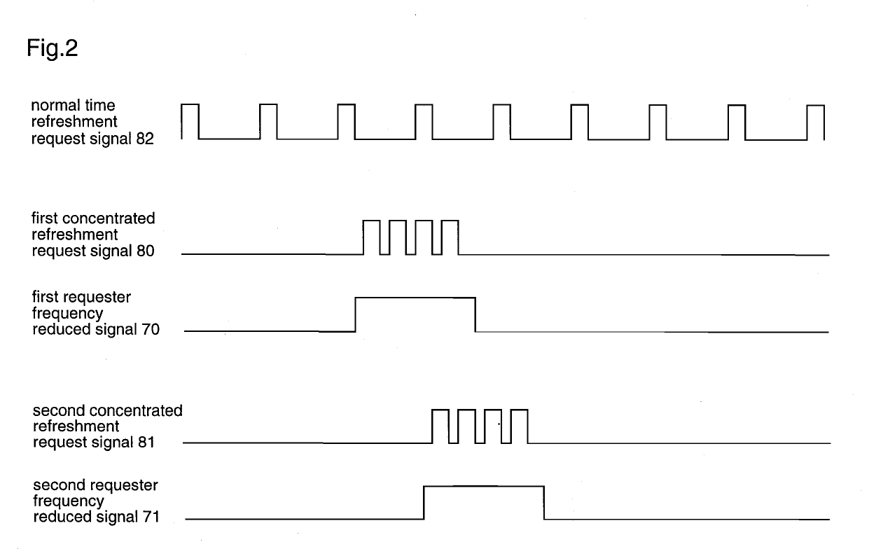

First, in the memory control device 1000 having a construction shown in FIG. 1, a value corresponding to 15.4 isec is set as a set value for the normal time refreshment frequency register 50, a value corresponding to 4 isec is set as a set value for the first concentrated refreshment frequency register 60, and a value corresponding to 2 isec is set as a set value for the second concentrated refreshment frequency register 61. The operation waveforms of the normal time refreshment request signal 82, the first and second concentrated request signals 80, 81, and the first and the second requester frequency reduced signals 70, 71 are shown in FIG. 2.

By these settings, the normal time refreshment requester 30 issues 4155 times of refreshment requests for 64 ms. On the other hand, the first requester 20 and the second requester 21 occur a blank period of 5.39 ms during the period of 64 ms. Therefore, the first concentrated refreshment requester 40 carries out 1347 times of refreshment requests during the blank period of the first requester 20, and the second concentrated refreshment requester 41 issues 2695 times of refreshment requests during the blank period of the second requester 21.

Accordingly, all the refreshments which are issued by the normal time refreshment requester 30, the first concentrated refreshment requester 40, and the second concentrated refreshment requester 41 amounts to 8197 times during the time period of 64 ms, thereby satisfying the required number of refreshments.

The occupancy bandwidth for the external memory 10 is here considered. Since when the first requester 20 and the second requester 21 are both in active periods, the normal time refreshment requester 30 occupies 1.3 MHz, the first requester 20 40 MHz, and the second requester 21 occupies 20 MHz, the occupancy bandwidth for the external memory 10 amounts to 61.3 MHz.

Since when the first requester 20 is in the active period and the second requester 21 is in the blank period, the normal time refreshment requester 30 occupies 1.3 MHz, the first requester 20 occupies 40 MHz, the second requester 21 occupies 10 MHz, and the second concentrated refreshment requester 41 occupies 10 MHz, the occupation band width for the external memory 10 amounts to 61.3 MHz.

Since when the first requester 20 is in the blank period and the second requester 21 is in the active period, the normal time refreshment requester 30 occupies 1.3 MHz, the first requester 20 occupies 35 MHz, the first concentrated refreshment requester 40 occupies 5 MHz, and the second requester 21 occupies 20 MHz, the occupation bandwidth for the external memory 10 amounts to 61.3 MHz.

Since when the first requester 20 and the second requester 21 are both in the blank periods, the normal time refreshment requester 30 occupies 1.3 MHz, the first requester 20 occupies 35 MHz, the first concentrated refreshment requester 40 occupies 5 MHz, the second requester 21 occupies 20 MHz, and the second concentrated refreshment requester 41 occupies 10 MHz, the occupation bandwidth for the external memory 10 amounts to 61.3 MHz.

In the following, the bandwidths for refreshments in cases where in the memory control device 1000 having a construction shown in FIG. 1, not refreshments according to the present invention are employed, but refreshments are carried out only by the normal time refreshment, or only by the first concentrated refreshment requester 40 and the second concentrated refreshment requester 41 are considered.

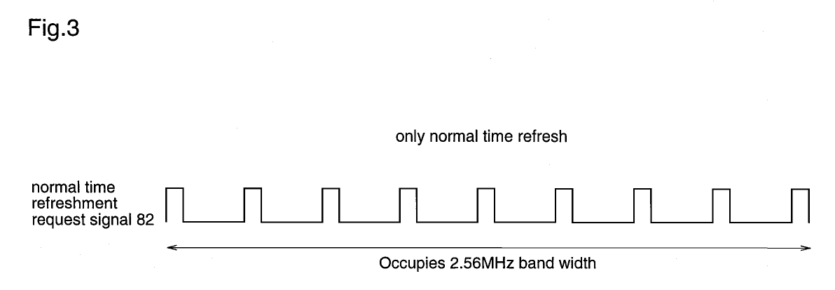

1) First of all, the operation of the refreshments which are performed in a case where the refreshments by the first concentrated refreshment requester 40 and the second concentrated refreshment requester 41 are not carried out, i.e., the refreshments are all carried out by the normal time refreshment requester 30, not by the first and the second concentrated refreshment requesters 40 and 41 in the memory control device 1000 having a construction shown in FIG. 1, is shown in FIG. 3.

In this case, since the normal time refreshment requester 30 is required to carry out 8192 times of refreshments during the time period of 64 ms, it occupies 2.56 MHz bandwidth. Accordingly, when the first requester 20 and the second requester 21 both stay in the active periods, the total occupation bandwidth amounts to 62.56 MHz.

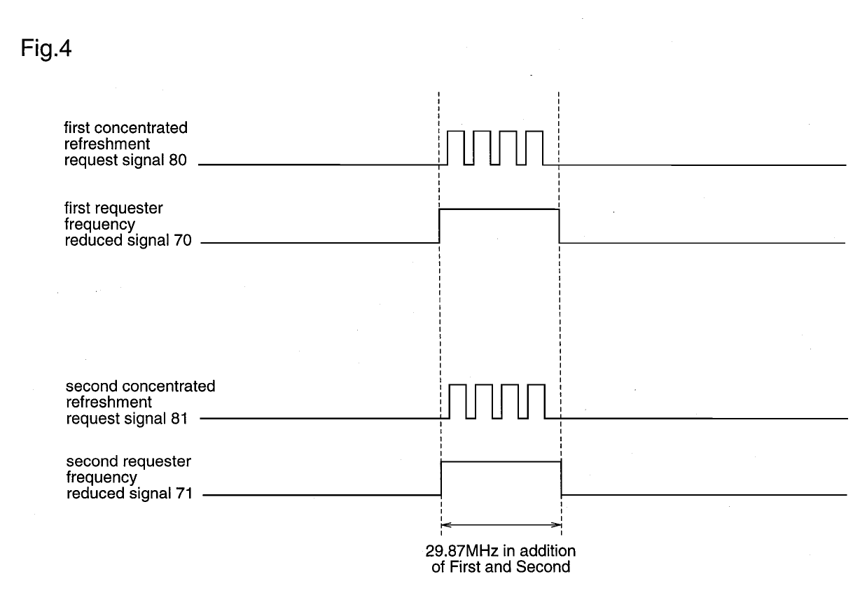

2) Next, the bandwidth for the refreshments in a case where the refreshments are carried out only by using the first concentrated refreshment requester 40 and the second concentrated refreshment requester 41 in the memory control device 1000 having a construction shown in FIG. 1, is shown in FIG. 4.

In this case, the sum of, the time number of refreshments which is to be issued by the first concentrated refreshment requester 40 during the blank period of the first requester 20 and the time number of refreshments which is to be issued by the second concentrated refreshment requester 21 during the blank period of the second requester 21, amounts to 8192 times during the time period of 64 ms.

Since there is a blank period of 5.39 ms during the time period of 64 ms, the first concentrated refreshment requester 40 and the second concentrated refreshment requester 41 are required to issue 8192 times of refreshments in total during this time period of 5.39 ms. From this, the sum of the bandwidths which are occupied by the refreshments which are carried out by the first concentrated refreshment requester 40 and the second concentrated refreshment requester 41 during when the first concentrated refreshment requester 40 and the second concentrated refreshment requester 41 both stay in the blank periods, amounts to 29.87 MHz, and with the bandwidths of the first requester 20 and the second requester 21 being added thereto, it amounts to 74.87 MHz.

This requires a bandwidth of 74.87 MHz which is further larger than the total occupation bandwidth of 62.56 MHz in a case where all the refreshments are carried out by the normal time refreshment requester 30, without employing refreshment operations by the first concentrated refreshment requester 40 and the second concentrated refreshment requester 41, in the memory control device of the construction shown in FIG. 1. It can be found from this fact that the bandwidth can be reduced by employing the method of the present invention.

In addition, in the above-described first embodiment, the requester which issues a memory access request against the access arbiter circuit may be an image processing circuit which carries out video image processing.

While in this case the image processing circuit periodically repeats the active periods during when the access frequency to the external memory is frequent and the blank periods during when the access frequency to the external memory is low, the memory access control circuit may employ, provided with a conditioned refreshment request circuit which is coordinative to the video image processing circuit, the signal indicating that the video image processing circuit is in the blank period as the access frequency reduced signal, thereby reducing the peak bandwidth for the refreshments and providing a simple memory access control method.

According to the memory control device 1000 of the first embodiment, the access control circuit for controlling accesses for the memory which requires refreshments is constructed, including an access arbiter circuit for arbitrating memory accesses from the requesters which request memory accesses, and a plurality of refreshment request circuits which are respectively connected to the access arbiter circuit, such that the access arbitrator circuit allows accesses on access requests from the requesters which are connected thereto on the basis of the access allowance frequencies which are respectively established for the respective requesters, one among the refreshment request circuits is a normal time refreshment request circuit which always continues to output requests to the access arbitrator circuit or outputs requests to the access arbitrator circuit with constant time intervals while other refreshment request circuits are conditioned refreshment request circuits which continue to output requests during when respective refreshment request issuing conditions are satisfied, which conditions are set for the respective refreshment request circuits, and further the access arbitrator circuit receives an access frequency reduced signal from a requester or requesters other than the refreshment request circuits among the requesters for which the access arbiter circuit carries out arbitration, the conditioned refreshment request circuits are provided in a number that is equal to the number of the outputted access frequency reduced signals, and the refreshment request issuing condition for the conditioned refreshment request circuit is made one that the corresponding access frequency reduced signal is being ON. Thereby, it is possible to perform the normal time refreshments and the concentrated refreshments with mixed in an appropriate manner, and thereby it is possible to avoid a high peak bandwidth occurring due to peaks in the memory accesses or congestion of memory refreshments.

In addition, since the access permission frequency that is set for the conditioned refreshment requester circuit in the access arbiter circuit is previously set based on the difference between the value when the access frequency reduced signal is being OFF and that value when it is being ON, which can be foreseen in the corresponding requester, and the access allowance frequency that is set for the normal time refreshment request circuit in the access arbiter circuit is previously set to such a value that enables to carry out refreshments of the number equal to the difference between the refreshment time number that is required for the memory to be carried out in a predetermined time period and the refreshment time number that is foreseen to be able to be carried out by the conditioned refreshment request circuit in the predetermined time period. Thereby, it is possible to provide a memory access control method which is simple and which can carry out, in order to reduce the peak bandwidth, normal time refreshments and concentrated refreshments with a predetermined ratio, based on information concerning variations in the bandwidths of the requesters which are foreseen a priori.

Further, by employing, as the requester which issues memory requests to the access arbiter circuit, a video image processing device which periodically repeats the active periods during when the access frequency to the external memory is frequent and the blank periods during when the access frequency to the external memory is low, providing conditioned refreshment request circuits which are coordinative to the video image processing circuit in a memory access control circuit, and employing the signal indicating that the video image processing circuit is in the blank period as an access frequency reduced signal, it is possible to provide a memory access control method which is simple and which can reduce the peak bandwidth for refreshments in an information processing device for processing video images.

### APPLICABILITY IN INDUSTRY

The memory access control circuit according to the present invention can provide effects of suppressing the peak bandwidth for memory accesses in accomplishing memory refreshments, and is useful as a memory access control circuit that is used in a large scale LSI performing an AV processing.

1. An optical disk device which arbitrates and controls accesses from plural requesters which raise access requests to a memory that requires refreshments, thereby to perform a memory control, comprising:
a memory access control circuit comprising an access arbitrator circuit which arbitrates memory access requests from the plural requesters, and plural refreshment requester circuits which raise requests for performing refreshment of the memory to the access arbitrator circuit, and
the plural refreshment requester circuits include a normal time refreshment requester circuit which continuously outputs a refreshment request for refreshing the memory to the access arbitrator circuit, or always outputs a refreshment request for refreshing the memory at a constant time interval to the access arbitrator circuit, and
one or plural conditioned refreshment request circuits which continue to issue refreshment requests for refreshing the memory to the access arbitrator circuit during while the refreshment request issuing conditions which are respectively set for the conditioned refreshment request circuits are satisfied.

2. A memory control device as defined in claim 1, wherein
all or a part of the plural requesters output an access frequency reduced signal which is being ON when the access frequency to the memory is below a predetermined value to the memory access control circuit,
the conditioned refreshment requester circuits are provided in the same number as all or a part of the requesters which output the access frequency reduced signal, and
the refreshment request issuing conditions for the respective conditioned refreshment requester circuits are that the corresponding access frequency reduced signals are being ON.

3. A memory control device as defined in claim 2, wherein
an access allowance frequency that is set for the conditioned refreshment requester circuit in the memory access control circuit is set based on the difference between the value when the access frequency reduced signal that is outputted from the conditioned refreshment requester circuit is OFF and that value when it is ON, and
an access allowance frequency that is set for the normal time refreshment requester circuit in the memory access control circuit is set so that refreshments of the number that is equal to the difference between the refreshment time number which are required for the memory to be performed in a predetermined time period and the refreshment time number which are carried out by the conditioned refreshment request circuit in the predetermined period of time are able to be carried out in the predetermined time period.

4. A memory control device as defined in claim 3, wherein,
the requester circuit which issues memory access requests to the access arbitrator circuit are image processing circuits which carry out image processing;
the requesters which are image processing circuits periodically repeat active periods during when the accesses to the external memory are frequent and blank periods during when the accesses thereto are seldom, and
the memory access control circuit has conditioned refreshment requester circuits corresponding to the requesters which are the image processing circuits, and employs signals which indicate that the requesters being the image processing circuits are in the blanking periods as the access frequency reduced signals.
